(19) United States
(12) Patent Application Publication
(10) Pub. No.: US 2026/0370803 A1
(43) Pub. Date: Nov. 19, 2026

(54) CROSS-COMPONENT PREDICTION IN INTER PICTURES

(71) Applicant: InterDigital CE Patent Holdings, SAS, Paris (FR)

(72) Inventors: Philippe BORDES, LAILLE (FR); Karam NASER, MOUAZE (FR); Franck GALPIN, THORIGNE-FOUILLARD (FR); Kevin REUZE, RENNES (FR)

(21) Appl. No.: 19/167,215

(22) PCT Filed: Mar. 18, 2024
(86) PCT No.: PCT/EP2024/057124

§ 371 Date: Sep. 19, 2025

(30) Foreign Application Priority Data
Mar. 22, 2023 (EP) 23305388.3
Jun. 26, 2023 (EP) 23306017.7

(51) Int. Cl. H04N 19/105; H04N 19/159; H04N 19/176; H04N 19/196; H04N 19/423; H04N 19/577

(52) U.S. Cl. CPC H04N 19/105; H04N 19/159; H04N 19/176; H04N 19/196; H04N 19/423; H04N 19/577

(57) ABSTRACT

A method comprising: obtaining a first block to reconstruct using a cross-component coding mode in which a model of the cross-component coding mode to apply to reconstruct the first block is obtained from a model of the cross-component coding mode associated to a reconstructed second block, wherein, the second block was reconstructed using a mode different from the cross-component coding mode.

### 1. CROSS REFERENCE TO RELATED APPLICATIONS

This application claims priority to European Application No. 23305388.3, filed Mar. 22, 2023 which is incorporated herein by reference in its entirety, and claims priority to European Application No. 23306017.7, filed Jun. 26, 2023 which is incorporated herein by reference in its entirety.

### 2. TECHNICAL FIELD

At least one of the present embodiments generally relates to a method and a device for applying an history-based cross-component intra prediction.

### 3. BACKGROUND

To achieve high compression efficiency, video coding schemes usually employ predictions and transforms to leverage spatial and temporal redundancies in a video content. During an encoding, pictures of the video content are divided into blocks of samples (i.e., Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

Intra prediction had been recently improved to better benefit from the correlations between components of a block. New tools consisting in a cross component intra prediction wherein chroma samples of a block are predicted from reconstructed luma samples of the block using a model were proposed. Some of these cross-component (CC) coding tools (or CC coding modes) use models of blocks previously coded using a CC coding tool. These CC coding tools, called Non-Adjacent CC prediction (NA-CCP) or history-based CC prediction (H-CCP), models of the CC coding tools applied to a block are kept for future use. When a current block is encoded using the CC coding tool, its parameters are selected in the set of CC coding tools models previously stored. An index of the selected model is then signaled for the current block. However, most of blocks of an inter slice are encoded in inter mode. Consequently, stored CC coding tools models are updated rarely. Stored CC coding tools models are therefore likely not well correlated with signal characteristics of the current block. This may jeopardize the efficiency of NA-CCP or H-CCP.

It is desirable to propose solutions allowing to overcome the above issue. In particular, it is desirable to propose a solution improving NN-CCP and H-CCP.

### 4. BRIEF SUMMARY

In a first aspect, one or more of the present embodiments provide a method a method comprising: obtaining a first block to reconstruct using a cross-component coding mode in which a model of the cross-component coding mode to apply to reconstruct the first block is obtained from a model of the cross-component coding mode associated to a reconstructed second block, wherein, the second block was reconstructed using a mode different from the cross-component coding mode.

In a second aspect, one or more of the present embodiments provide a method comprising: applying a cross-component coding mode to a first block, a model of the cross-component coding mode to apply to the first block being obtained from a model of the cross-component coding mode associated to a second block encoded before the first block, wherein, the second block was encoded using a mode different from the cross-component coding mode.

According to an embodiment of the first and the second aspect, the model of the cross-component coding mode associated to the reconstructed second block is stored in at least one cell corresponding to the second block of a first buffer storing coding parameters of blocks of a current picture comprising the first and the second block.

According to an embodiment of the first and the second aspect, a cell of the at least one cell inherited the model of the cross-component coding mode associated to the reconstructed second block from another cell corresponding to a reference block of a reference picture designated by motion information of the second block, the another cell being comprised in a second buffer storing coding parameters of blocks of the reference picture.

According to an embodiment of the first and the second aspect, the cell of the at least one cell inherited the model of the cross-component coding mode associated to the reconstructed second block from the another cell depending on a value representative of a quality of the model of the cross-component coding mode inherited by the first block from the second block.

According to an embodiment of the first and the second aspect, the model of the cross-component coding mode to apply to the first block is selected from a table storing models of the cross-component coding mode of last reconstructed blocks for which a model of the cross-component coding mode is available, said table being updated after a reconstruction of a block for which a model of the cross-component coding mode is available.

According to an embodiment of the first and the second aspect, the model of the cross-component coding mode to apply to the first block is selected from models of the cross-component coding mode of a candidate region list or of candidate block list, regions of the candidate region list and blocks of the candidate block list being in a neighborhood of the first block.

According to an embodiment of the first and the second aspect, a model of the cross-component coding mode is computed for reconstructed blocks predicted using a mode different from the cross-component coding mode.

In a third aspect, one or more of the present embodiments provide a method for decoding a current picture comprising reconstructing a current block of the current picture according to a cross-component coding mode applying the method of the first aspect.

In a fourth aspect, one or more of the present embodiments provide a method for encoding a current picture comprising reconstructing a current block of the current picture according to a cross-component coding mode applying the method of the second aspect.

In an embodiment of the third or fourth aspect, information representative of the model of the cross-component coding mode applied to reconstruct the first block is stored in at least one cell corresponding to the current block of a current buffer storing coding parameters associated to the current picture.

In a fifth aspect, one or more of the present embodiments provide a device comprising electronic circuitry configured for:
obtaining a first block to reconstruct using a cross-component coding mode in which a model of the cross-component coding mode to apply to reconstruct the first block is obtained from a model of the cross-component coding mode associated to a reconstructed second block, wherein, the second block was reconstructed using a mode different from the cross-component coding mode.

In a sixth aspect, one or more of the present embodiments provide a device comprising electronic circuitry configured for:
applying a cross-component coding mode to a first block, a model of the cross-component coding mode to apply to the first block being obtained from a model of the cross-component coding mode associated to a second block encoded before the first block, wherein, the second block was encoded using a mode different from the cross-component coding mode.

In an embodiment of the fifth or the sixth aspect, the model of the cross-component coding mode associated to the reconstructed second block is stored in at least one cell corresponding to the second block of a first buffer storing coding parameters of blocks of a current picture comprising the first and the second block.

In an embodiment of the fifth or the sixth aspect, a cell of the at least one cell inherited the model of the cross-component coding mode associated to the reconstructed second block from another cell corresponding to a reference block of a reference picture designated by motion information of the second block, the another cell being comprised in a second buffer storing coding parameters of blocks of the reference picture.

In an embodiment of the fifth or the sixth aspect, the cell of the at least one cell inherited the model of the cross-component coding mode associated to the reconstructed second block from the another cell depending on a value representative of a quality of the model of the cross-component coding mode inherited by the first block from the second block.

In an embodiment of the fifth or the sixth aspect, the model of the cross-component coding mode to apply to the first block is selected from a table storing models of the cross-component coding mode of last reconstructed blocks for which a model of the cross-component coding mode is available, said table being updated after a reconstruction of a block for which a model of the cross-component coding mode is available.

In an embodiment of the fifth or the sixth aspect, the model of the cross-component coding mode to apply to the first block is selected from models of the cross-component coding mode of a candidate region list or of candidate block list, regions of the candidate region list and blocks of the candidate block list being in a neighborhood of the first block.

In an embodiment of the fifth or the sixth aspect, a model of the cross-component coding mode is computed for reconstructed blocks predicted using a mode different from the cross-component coding mode.

In a seventh aspect, one or more of the present embodiments provide a system for decoding a current picture comprising electronic circuitry configured for reconstructing a current block of a current picture according to a cross-component coding mode comprising the device of the fifth aspect.

In a eighth aspect, one or more of the present embodiments provide a system for encoding a current picture comprising electronic circuitry configured for reconstructing a current block of a current picture according to a cross-component coding mode comprising the device of the sixth aspect.

In an embodiment of the seventh or sixth aspect, information representative of the model of the cross-component coding mode applied to reconstruct the first block is stored in at least one cell corresponding to the current block of a current buffer storing coding parameters associated to the current picture.

In a nineth aspect, one or more of the present embodiments provide a computer program comprising program code instructions for implementing the method according to the first, the second, the third or the fourth aspect.

In a tenth aspect, one or more of the present embodiments provide a non-transitory information storage medium storing program code instructions for implementing the method according to the first, the second, the third or the fourth aspect.

### 5. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6A illustrates the LM_Chroma CCLM mode;

FIG. 6B illustrates the MDLM_T CCLM mode;

FIG. 6C illustrates the MDLM_L CCLM mode;

FIG. 7 illustrates classes used to determine models parameters in the Multi-model LM (MMLM) modes;

FIG. 8 illustrates a 5-tap spatial filter component of a 7-tap convolutional filter used in the CCCM mode;

FIG. 9 illustrates a reference area consisting of six lines/columns of chroma samples above and left of a CU used in the CCCM mode;

FIG. 10 illustrates a general process of the CC coding tools (e.g., CCLM, MMLM, CCCM);

FIG. 11 illustrates a set of candidate regions for a non-adjacent cross component prediction mode;

FIG. 12 illustrates a spanInfo process;

FIG. 13 depicts schematically a modified method for encoding video data according to embodiments;

FIG. 14 depicts schematically a method for decoding encoded video data according to an embodiment; and,

FIG. 15 depicts a method for inheriting candidates for a block coded in inter in a current picture.

### 6. DETAILED DESCRIPTION

The following examples of embodiments are described in the context of a video format similar to VVC (ISO/IEC 23090-3—MPEG-I: Versatile Video Coding (VVC)/ITU-T H.266). However, these embodiments are not limited to the video coding/decoding method corresponding to VVC. These embodiments are in particular adapted to various video formats comprising (and derived from) for example HEVC (ISO/IEC 23008-2—MPEG-H Part 2, High Efficiency Video Coding/ITU-T H.265)), AVC ((ISO/CEI 14496-10), EVC (Essential Video Coding/MPEG-5), AV1, AV2 and VP9.

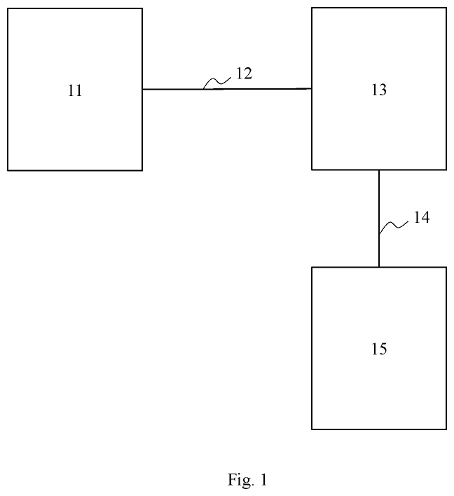

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures. A post-processing may be applied to the decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

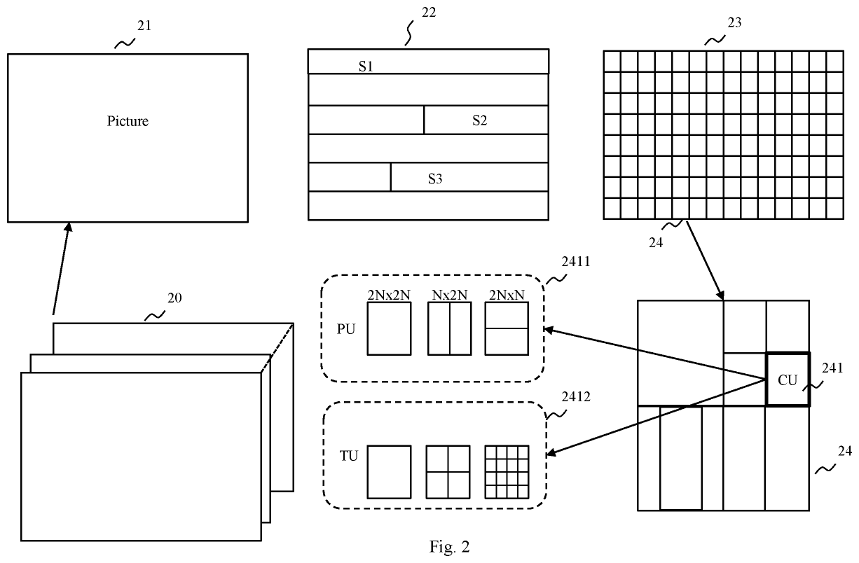

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e., the parent node) of the hierarchical tree and can be partitioned in a plurality of CU (i.e., child nodes). Each CU becomes a leaf of the hierarchical tree if it is not further partitioned in smaller CU or becomes a parent node of smaller CU (i.e., child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e., it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e., a PU) and transform (i.e., a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) .$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding formats, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

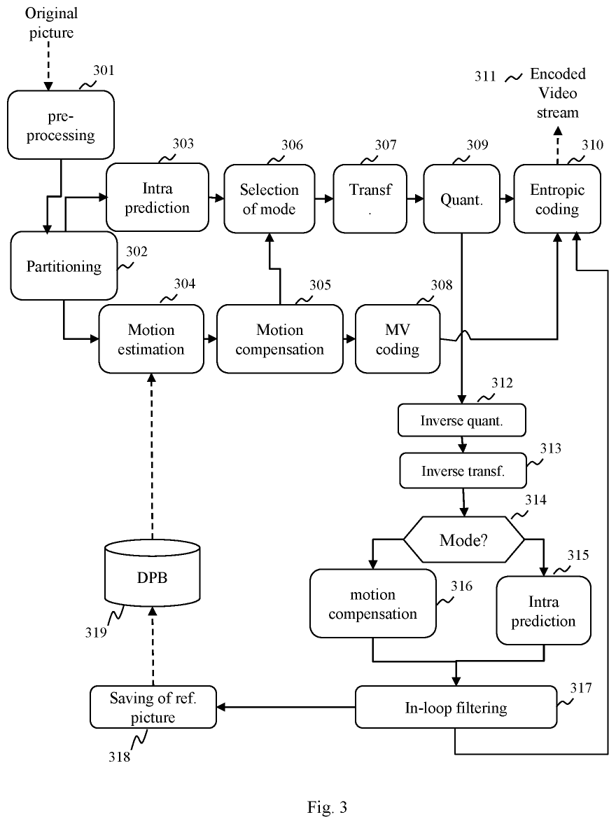

FIG. 3 depicts schematically a method for encoding a video stream executed by an encoding module. For instance, the method for encoding of FIG. 3 is executed by the system 11. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc.

For each block, the encoding module determines then a coding mode between an intra prediction and an inter prediction.

The intra prediction consists of predicting, in accordance with an intra prediction method, during a step 303, the pixels of a current block from a prediction block derived from pixels of reconstructed blocks situated in a causal neighbourhood of the current block to be encoded. The result of the intra prediction is an intra prediction mode indicating which pixels of the blocks in the neighbourhood to use, and a residual block resulting from a calculation of a difference between the current block and the prediction block.

The usual intra prediction described above is adapted to the intra prediction in one component (Y or Cb or Cr), i.e., predicted samples are predicted only from reference samples from the same component. This usual intra prediction could be called intra component prediction. Intra prediction has been recently enriched by several tools (or modes) consisting in intra prediction between different components, i.e., samples of a first component are predicted using samples of a second component. These tools (i.e., modes) are generally called cross-component prediction tools.

For example, a Cross-Component Linear Model (CCLM) prediction mode was proposed, for which chroma samples of a CU are predicted based on reconstructed luma samples of the same CU by using a cross-component (CC) prediction model in the form of a linear model as follows:

pred_{C}_{ₖ}(i,j)=α_{C}_{ₖ}·rec_{L}′(i,j)+β_{C}_{ₖ} (eq.1)

where pred_{C}_{ₖ}(i, j) represents a predicted chroma sample of a chroma component Cₖ (for example Cₖ=U or V for the YUV format) in a CU and rec_{L}′(i, j) represents reconstructed luma samples, the luma samples being eventually down-sampled depending of the chroma format of the CU. CCLM parameters α_{C}_{ₖ} and β_{C}_{ₖ} are derived for each chroma component with a set of neighboring chroma samples of the same chroma component and their corresponding luma samples (eventually down-sampled). In some implementations, a subset of neighboring chroma samples (e.g., at most four) and their corresponding luma samples are used. Also, the position of the neighboring samples may be signaled in the bitstream. For example, in VVC there exists three CCLM modes (LM_CHROMA, MDLM_T, MDLM_L) that differ with the location of the neighboring chroma samples.

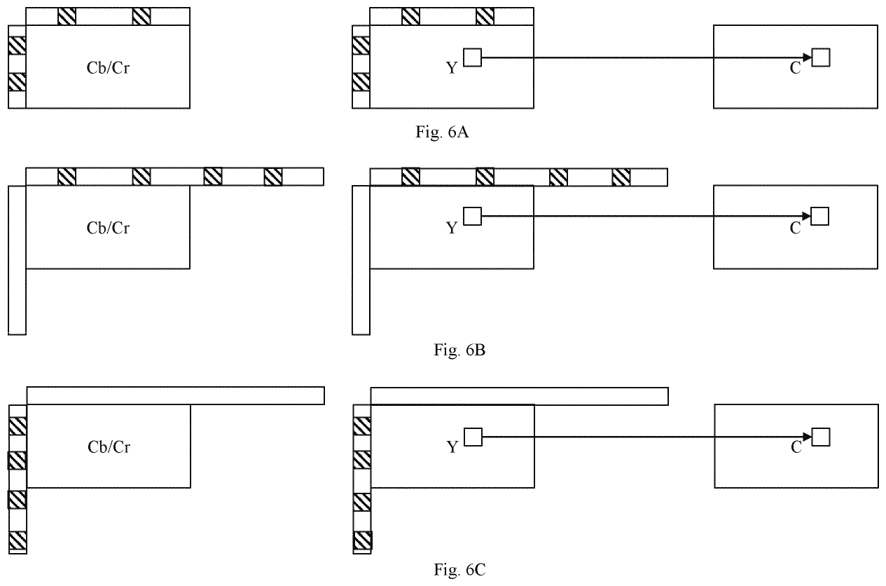

FIG. 6A illustrates the LM_Chroma CCLM mode.

FIG. 6B illustrates the MDLM_T CCLM mode.

FIG. 6C illustrates the MDLM_L CCLM mode.

The CCLM mode to be used is coded per CU.

The set of neighboring luma samples at the selected positions are down-sampled (if required by the chroma format) and compared to find two smaller values: x⁰_{A} and x¹_{A}, and two larger values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and y_{B} are derived as follows:

Xₐ=(x⁰_{A}+x¹_{A}+1)>>1;X_{b}=(x⁰_{B}+x¹_{B}+1)>>1;

Yₐ=(y⁰_{A}+y¹_{A}+1)>>1;Y_{b}=(y⁰_{B}+y¹_{B}+1)>>1 (eq.2)

Finally, the linear model parameters α_{C}_{ₖ} and β_{C}_{ₖ} are obtained according to the following equations:

α_{C}_{ₖ}=(Yₐ−Y_{b})/(Xₐ−X_{b}) (eq.3)

β_{C}_{ₖ}=Y_{b}−α_{C}_{ₖ}·X_{b} (eq.4)

There exist several variants to CCLM, where a) the location and/or the number of the neighboring samples used to derive the model, b) the method to derive the linear model parameters (α_{C}_{ₖ}, β_{C}_{ₖ}), or c) the luma down-sampling filter, may differ.

For example, in a variant called MMLM (for multi-model LM), there can be more than one linear model between the luma samples and chroma samples in a CU. In this method, neighboring luma samples and neighboring chroma samples of the current block are classified into several classes, each class is used as a training set to derive a linear model (i.e., particular α_{C}_{ₖ} and β_{C}_{ₖ} are derived for a particular class). Furthermore, the samples of the current luma block are also classified based on the same rule for the classification of neighboring luma samples.

In some implementations of MMLM described for instance in document K. Zhang, J. Chen, L. Zhang, M. Karczewicz, “Enhanced Cross-component Linear Model Intra-prediction,” JVET-D0110, neighboring samples are classified into M classes, where M is “2” or “3”. The MMLM method with M=2 and M=3 are designed as two appended CC prediction modes named MMLM2 and MMLM3, besides the original CCLM mode. The encoder chooses the optimal mode in a RDO process and signal the mode.

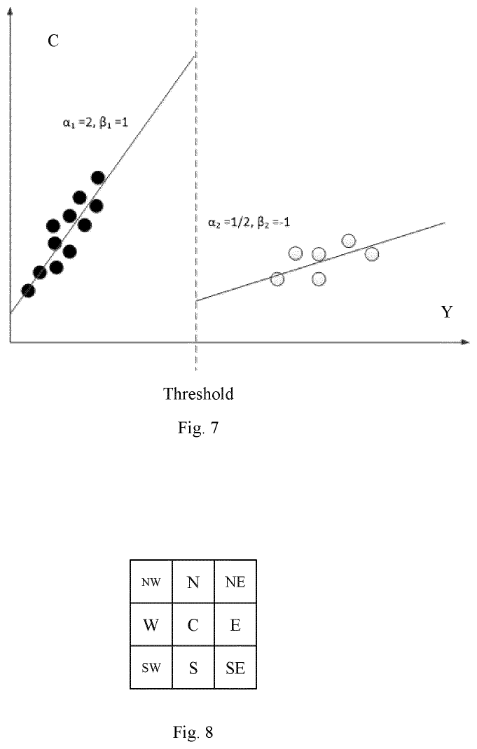

When M is equal to “2”, FIG. 7 shows an example of classifying the neighboring samples into two groups. Threshold is calculated as the average value of the neighboring reconstructed Luma samples. A neighboring sample with Rec′_{L}[x,y]<=Threshold is classified into group “1”; while a neighboring sample with Rec′_{L}[x,y]>Threshold is classified into group “2”.

In a variant, a slope adjustment is applied to cross-component linear model (CCLM) and to Multi-model LM prediction. The adjustment is tilting the linear function which maps luma values to chroma values with respect to a center point determined by the average luma value of the reconstructed luma samples.

In a variant of CCLM called CCCM, the linear model of CCLM is replaced by a CC prediction model taking the form of an adaptive 7-Tap convolutional filter. The 7-tap convolutional filter consists of a 5-tap spatial filter component, a nonlinear term P and a bias term B. The input to the spatial 5-tap spatial filter component consists of (eventually) down-sampled luma samples comprising a center luma sample C which is collocated with a chroma sample to be predicted, a luma sample N above the center luma sample C, a luma sample S below the center luma sample C, a sample W on the left of the center luma sample C and a sample E on the right of the center luma sample C as illustrated in FIG. 8.

The nonlinear term P is represented as power of two of the center luma sample C and scaled to a range of sample values specified by a bit depth value bitdepth:

P=(C*C+midVal)>>bitDepth

That is, for bitdepth=10:

P=(C*C+512)>>10

The bias term B represents a scalar offset between the input and output (similarly to the offset term in CCLM) and is set to a middle chroma value (for example 512 for bitdepth=10).

The predicted chroma samples for a chroma component Cₖ (i.e. the output of the 7-tap convolutional filter) is calculated as a convolution between filter coefficients ci_{C}_{ₖ} and the input values (the reconstructed luma samples C, N, S, E, W and the nonlinear term P and the bias B) and clipped to the range of valid chroma samples:

predChromaVal_{C}_{ₖ}=c0_{C}_{ₖ}·C+c1_{C}_{ₖ}·N+c2_{C}_{ₖ}·S+c3_{C}_{ₖ}·E+c4_{C}_{ₖ}·W+c5_{C}_{ₖ}·P+c6_{C}_{ₖ}·B (eq.5)

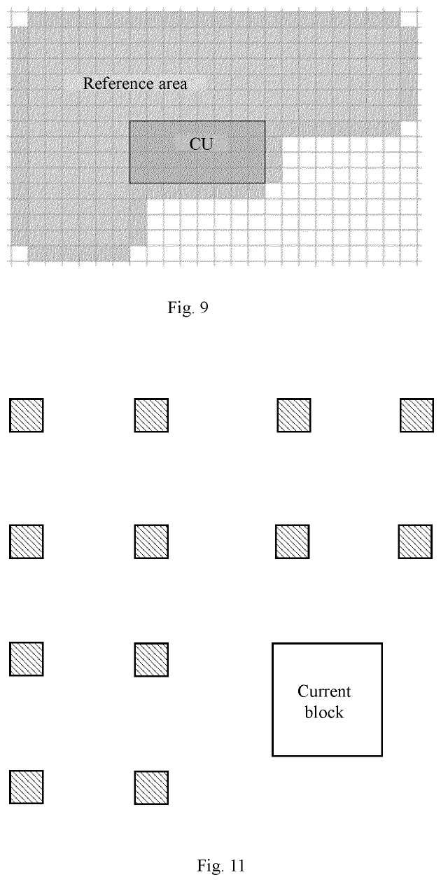

The filter coefficients ci_{C}_{ₖ} are calculated by minimizing a MSE between predicted and reconstructed chroma samples in a reference area. FIG. 9 illustrates the reference area which consists of six lines/columns of chroma samples above and left of the CU. Reference area extends one CU width to the right and one CU height below the CU boundaries. Area is adjusted to include only available samples.

In a variant, called gradient and location (GL) CCCM, some of the inputs of the spatial 5-tap spatial filter may be local gradients as follows:

predChromaVal=c0·C+c1·Gy+c2·Gx+c3·Y+c4·X+c5·P+c6·B

Where Gy and Gx are vertical and horizontal gradients, respectively, and are calculated as follows:

Gy=(2N+NW+NE)−(2S+SW+SE)

Gx=(2W+NW+SW)−(2E+NE+SE)

Luma samples NW, NE, SW and SE are illustrated in FIG. 8.

Moreover, the Y and X parameters are vertical and horizontal coordinates of the center luma sample location.

In another variant, the reconstructed luma samples are not down-sampled.

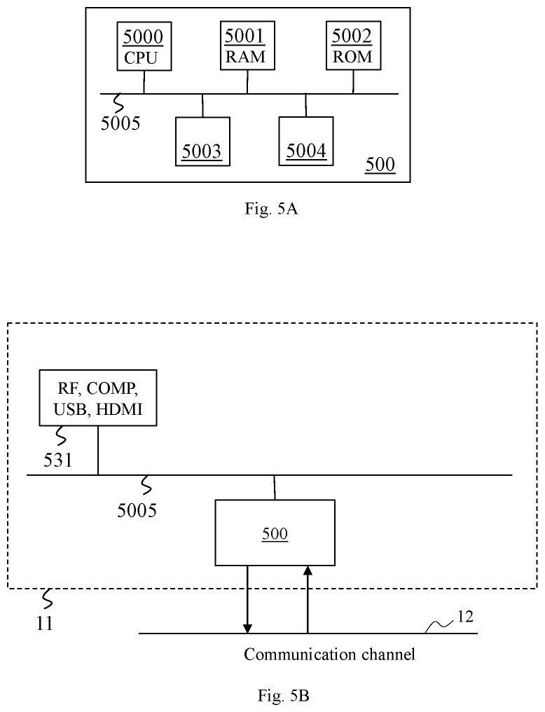

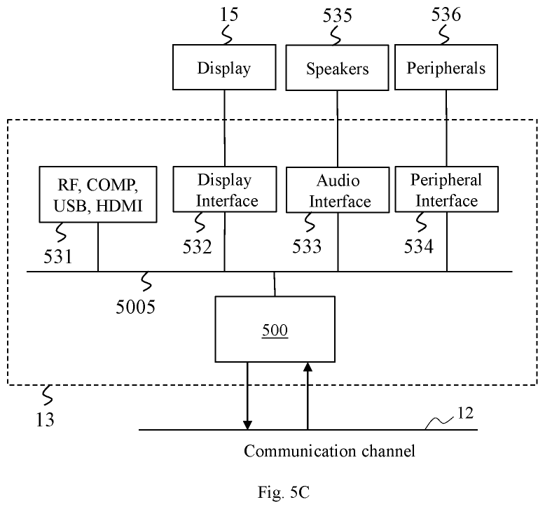

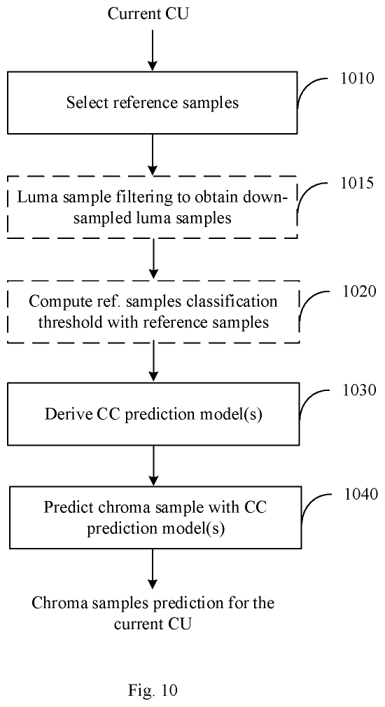

A general process of the chroma prediction modes using cross-component luma model (e.g., CCLM, MMLM, CCCM) is depicted in FIG. 10. The process of FIG. 10 is executed by a processing module similar to the processing module described in the following in relation to FIG. 5A.

In a step 1010, the processing module selects reference samples (reconstructed luma and chroma sample values) from the neighborhood of the current CU. For example, CCCM uses six lines of reference samples above the current CU and six columns of reference samples on the left of the current CU.

In a step 1015 the processing module filters the reconstructed luma sample values to obtain down-sampled luma samples. Step 1015 is optional.

In a step 1020, the processing module determines a threshold to classify the reference samples in at least two classes. Step 1020 is optional and is applied when multiple CC prediction models are used as in MMLM.

In a step 1030, the processing module derives the parameters of the (multi-) CC prediction model(s) (see coefficients ci_{C}_{ₖ}) from the reference luma and chroma sample values.

In a step 1040, the processing module uses the CC prediction model(s) to derive the chroma sample prediction values from the co-located (eventually down-sampled) reconstructed luma sample values.

In another variant of CCCM called Non-Adjacent Cross Component Prediction (NA-CCP), samples in regions non-adjacent to a current block can be used to derive a CCCM model for the current block as described in document K. Zhang, L. Zhang, Z. Deng, “Non-EE2: Non-Local Cross-Component Prediction,” document JVET-AC0176, 29th Meeting, by teleconference, 11-20 Jan. 2023. A candidate region list with “6” candidates is constructed by checking potential 8×8 regions in a neighborhood of the current block in a specified order. If a checked region is available, it is put into the candidate region list. The top-left positions of the potential 8×8 regions are predetermined as depicted in FIG. 11. A flag is signaled to indicate whether NA-CCP is applied to a chroma block. If NA-CCP is applied, an index is signaled to indicate which candidate in the candidate region list is used to derive the CCCM model for the current block.

As can be seen, in NA-CCP, it is considered that non-adjacent regions may be more correlated with the chroma block signal of the current block than adjacent regions.

In another variant of CCLM and CCCM named History-based cross-component prediction (H-CCP), a table H-CCLM of CCLM models of previous blocks encoded according to the CCLM mode and a table H-CCCM of CCCM models of previous blocks encoded according to the CCCM mode are maintained similarly to a history-based motion vector prediction (HMVP) table. In HMVP, motion information of a previously coded block is stored in a table and used as motion vector predictor candidate for the current CU. The table with multiple HMVP candidates is maintained during the encoding/decoding process. The table is reset (emptied) when a new CTU row is encountered. The HMVP table size is generally set to be “6”. When inserting a new motion vector candidate to the table, a constrained first-in-first-out (FIFO) rule is utilized wherein redundancy check is firstly applied to remove duplicate candidates in the HMVP table.

Regarding H-CCP, after decoding a CCLM or CCCM encoded block, the corresponding table (the H-CCLM table or the H-CCCM table) is updated with the CCLM or CCCM model of the block. In an example of implementation of H-CCP, the size of either H-CCLM table or H-CCCM table is also “6”. If the current block is coded with CCLM or CCCM mode, a flag is signaled to indicate whether H-CCP is applied. If H-CCP is used, an index is further signaled to indicate which candidate model in the H-CCLM table or H-CCCM table is selected.

As can be seen, compared to the method of FIG. 10, H-CCP avoid computing a CCLM and CCCM model for each block encoded according to the CCLM or CCCM mode. It amounts at replacing step 1030 of FIG. 10 by a step of selection of a model in the tables H-CCLM or H-CCCM.

The H-CCP mode has some limitations in inter slices. Indeed, since most of the blocks of inter-slices are coded in inter mode, the H-CCLM table or H-CCCM table are updated rarely. Consequently, the H-CCLM and H-CCCM tables risk to contain model parameters likely not well correlated with Chroma signal characteristics of the current block. It may therefore jeopardize the efficiency of the H-CCP mode.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e., RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal. When the current block is coded according to an intra prediction mode, an intra prediction mode and the transformed and quantized residual block are encoded by an entropic encoder during a step 310. When the current block is encoded according to an inter prediction, when appropriate, a motion vector of the block is predicted from a prediction vector selected from a set of motion vector predictors derived from reconstructed blocks situated in a spatial and temporal vicinity of the block to be encoded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream (i.e., encoded video data) 311.

Metadata such as SEI (supplemental enhancement information) messages can be attached to the encoded video stream 311. A SEI message as defined for example in standards such as AVC, HEVC or VVC (or in standard Versatile supplemental enhancement information (VSEI) messages for coded video bitstreams—H.274) is a data container or a syntax structure associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the intra prediction mode corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

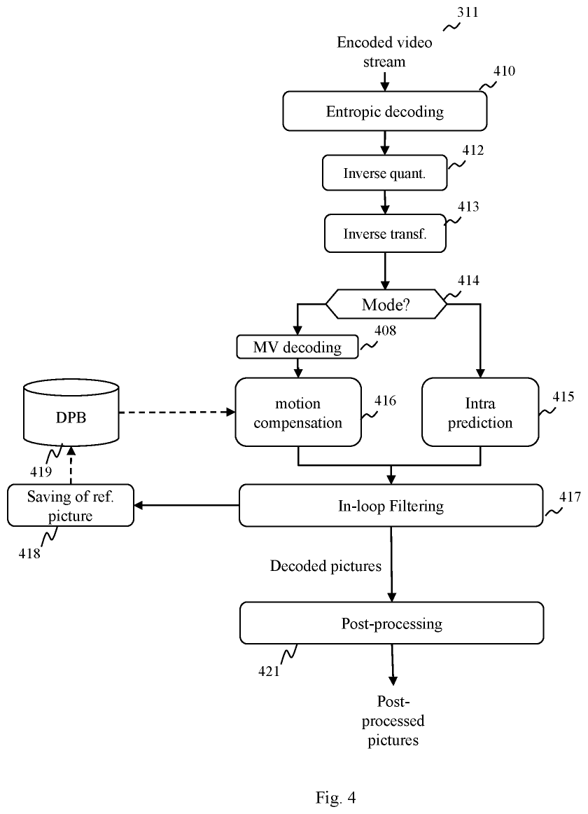

FIG. 4 depicts schematically a method for decoding the encoded video stream 311 encoded according to method described in relation to FIG. 3 executed by a decoding module. For instance, the method for decoding of FIG. 4 is executed by the system 13. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain an intra prediction mode and a residual block. Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed.

Following the in-loop filtering (i.e., following the generation of the decoded pictures), a post-processing step 421 may be applied.

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams (i.e., video data) and to provide a sequence of decoded pictures. If the processing module 500 implements an encoding module, the communication interface 5004 enables for instance the processing module 500 to receive a sequence of original picture data to encode and to provide an encoded video stream.

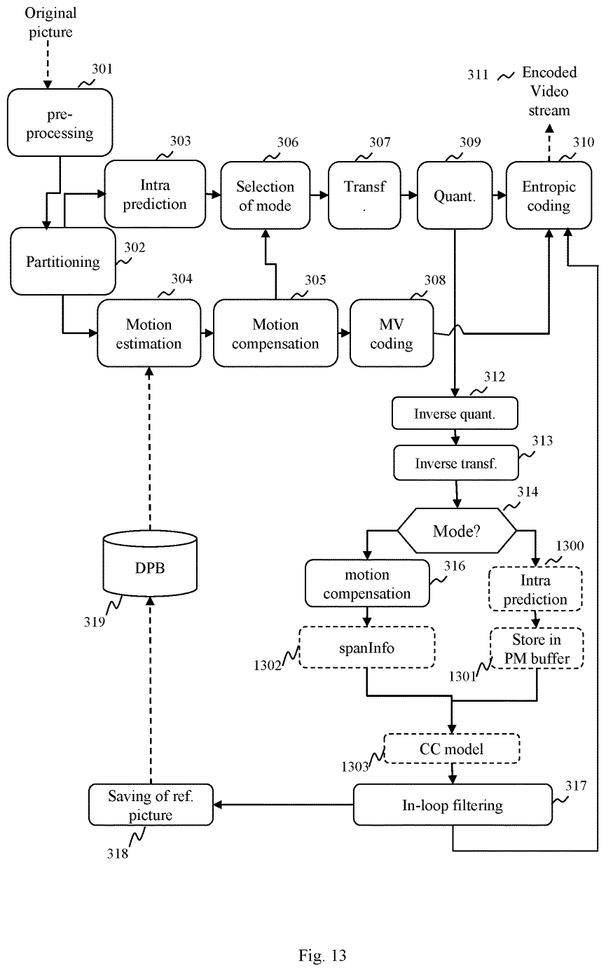

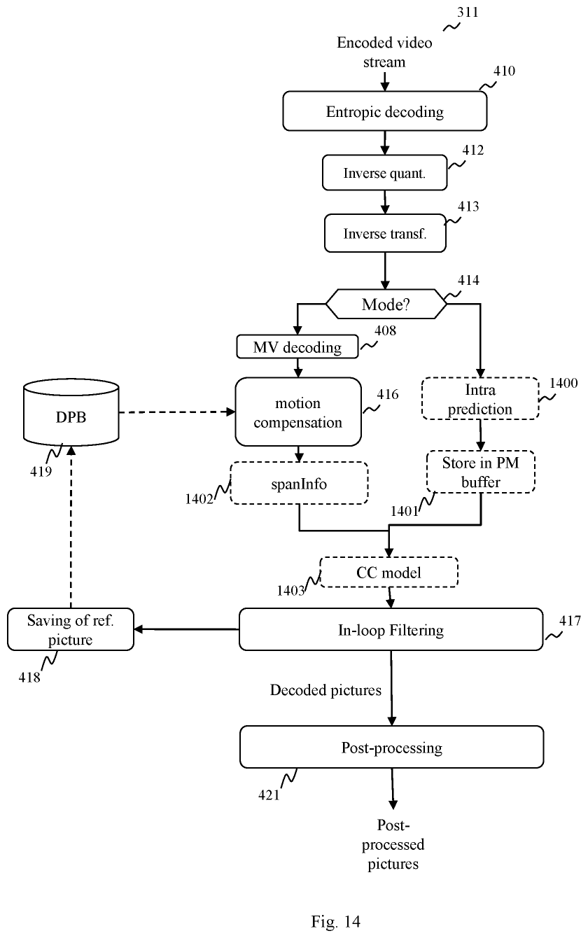

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 14 and/or an encoding method described in relation to FIG. 13, these methods comprising various aspects and embodiments described below in this document.

All or some of the algorithms and steps of the methods of FIG. 13 or 14 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted or configured to implement at least partially the methods of FIG. 13 or 14.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module 500 take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for applying a CC coding tool (e.g., CCLM, MMLM, CCCM or any variant of these coding tools described in this document).

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for applying a CC coding tool (e.g., CCLM, MMLM, CCCM or any variant of these coding tools described in this document).

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can include a signal indicating how to apply a CC coding tool. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, various embodiments of the H-CCP and NA-CCP modes are proposed.

In a first embodiment, CCLM and CCCM model parameters are associated to inter coded blocks.

In some implementations, a picture can be associated to a buffer, called Prediction Mode (PM) buffer in the following. The PM buffer allows storing some coding parameters for blocks of the associated picture. This buffer is stored in the DPB 319 or 419 along with the associated pictures. In that case, reference pictures of the DPB are associated to PM buffers. A PM buffer can be viewed as a grid of cells of pre-determined size (ex: 4×4). A cell of the PM buffer is filled with the coding parameters of a block of the associated picture covering this cell. For instance, a block of size 16×16 covers “16” 4×4 cells, each cell of the “16” 4×4 cells being filled with the coding parameters of the corresponding 16×16 block.

In that way, later in the process of coding/decoding other blocks of the associated picture or of subsequent pictures, one can easily access to the coding parameters of a previously coded block. For example, the coding parameters include information representing an intra/inter mode of a block, the motion vector(s) of a block, the Picture Order Count (POC) of (a) reference picture(s) used in inter prediction of a block, etc.

In case of a block of a current picture coded in inter mode, a process called spanInfo allows the inter coded block to inherit from the coding parameters of a reference block used for inter predicting the inter coded block. More precisely, the cell(s) of the PM buffer associated to the current picture corresponding to the inter coded block inherits from the coding parameters stored in the cell(s) corresponding to the reference block of the PM buffer associated to the reference picture comprising the reference block.

Another process called storeInfo allows storing coding parameters of a current block in the PM buffer associated with the current picture, in the cell(s) corresponding to the current block.

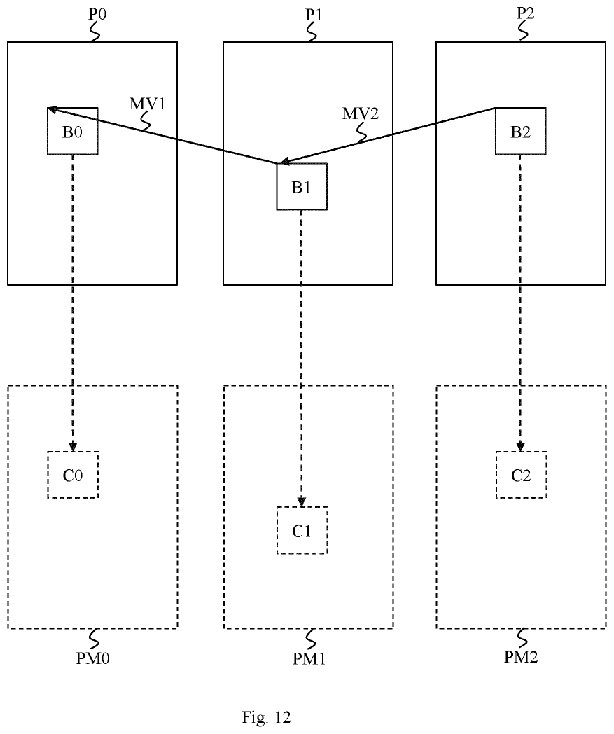

FIG. 12 illustrates an example of application of the spanInfo process.

FIG. 12 represents “3” pictures P0, P1 and P2. Picture P0 (respectively picture P1 and P2) is associated to a PM buffer PM0 (respectively picture PM1 and PM2).

A block B0 of picture P0 is encoded in INTRA mode. The coding parameters of block B0 are stored in a cell C0 of the PM buffer PM0. A block B1 of picture P1 is inter coded using block B0 as a reference block (block B0 is pointed by a motion vector MV1 of block B1). The block B1 is associated to a cell C1 of the PM buffer PM1. The cell C1 inherits from the coding parameters (i.e., the coding parameters of block B0) stored in the cell C0 of the PM buffer PM0. A block B2 of picture P2 is inter coded using block B1 as a reference block (block B1 is pointed by a motion vector MV2 of block B2). The block B2 is associated to a cell C2 of the PM buffer PM2. The cell C2 inherits from the coding parameters (i.e., the coding parameters of block B0) stored in the cell C1 of the PM buffer PM1.

The spanInfo process is invoked before the encoding/decoding of a current block coded in inter using the motion information of the current block (i.e., motion vector and index of the reference picture), while the storeInfo process is invoked after the encoding/decoding of a current block. Typically, regarding B1 (respectively B2), the spanInfo process is applied just before the encoding/decoding of block B1 (respectively B2) so that cell C1 (respectively C2) inherits from the parameters stored in cell C0 (respectively C1) that may be used to encode B1 (respectively B2).

In general, edges of a reference blocks are not aligned on edges of encoded blocks as defined by the partitioning of the reference picture and may cover several encoded blocks of the reference picture. In that case, the spanInfo process uses the cell of the reference picture corresponding to a pre-determined location in the reference block (the center of the reference block for example). A specific inheritance process is also applied to bi-predicted inter blocks to determine which motion vector and reference picture index to use.

In the first embodiment, it is proposed to modify the PM buffer so that it allows storing CCCM and CCLM models parameters, or to manage another PM buffer for storing CCCM and CCLM models, similarly to the regular PM buffer. With such modified PM buffers, the spanInfo process allows a cell corresponding to an inter coded block inheriting CCCM or CCLM models from another cell. Cells of PM buffers corresponding to inter blocks could therefore store CCCM or CCLM models. In case a current block of a current picture is coded in CCLM or CCCM mode, the CCLM or CCCM model is stored in the cell(s) corresponding to the current block of the PM buffer associated to the current picture using the storeInfo process.

Doing so, in inter slices, when applying the H-CCP mode to a current block, the frequency of updating of the H-CCLM and H-CCCM tables increases. Indeed, the number of blocks associated to CCLM or CCCM models is not restricted to blocks actually encoded using the CCLM or the CCCM mode, but any type of block can be associated to CCLM or CCCM models. In addition, since H-CCLM and H-CCCM tables are reset when a new CTU row is encountered, the likelihood of finding a block associated to a CCLM or CCCM model in a current CTU row of an inter slice is increased. Even if some of the blocks of the CTU row were not encoded using the CCLM or CCCM mode, since they were inter predicted either directly or indirectly from a block encoded using the CCCM or CCLM mode, it can be considered that the likelihood that the signal used to determine the CCLM or CCCM models is correlated to the chroma signal of the current block is high.

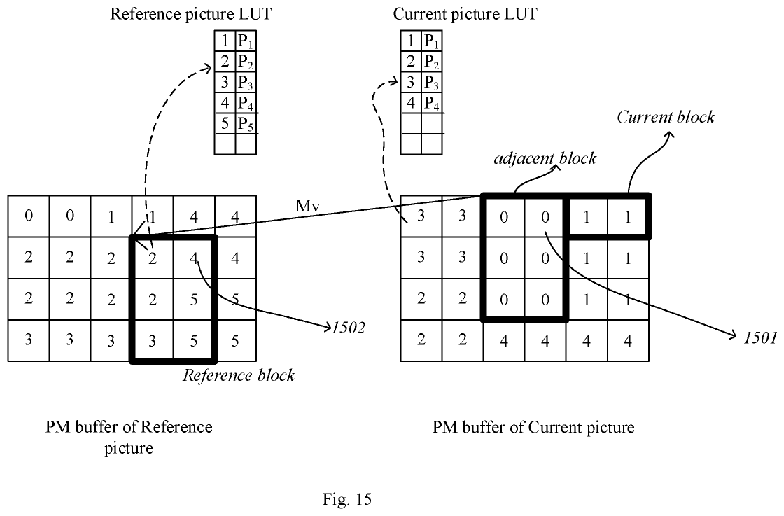

Similarly, if the current block inherits information from a neighboring position (1501) located into an adjacent block coded in inter, the spanInfo process can be invoked to use the coding parameters stored in the PM buffer associated with at least one reference block used to predict the adjacent block at a corresponding position in the reference block (1502), as depicted in FIG. 15. In case the adjacent block is bi-predicted, some predefined rules may be used to select one reference. For example, using the reference with minimal POC (Picture Order Count) distance with the POC of the current picture.

For all the blocks coded in inter, the spanInfo process can be invoked to fill-in the current PM buffer with CC-model parameters stored in the reference PM buffer and copied into the current PM buffer.

FIG. 13 depicts schematically a modified method for encoding video data according to embodiments.

Comparing to the method of FIG. 3, the method of FIG. 13 comprises new steps 1301 and 1302 and step 315 is replaced by a step 1300. All additional steps are executed for example by the processing module 500 of the system 11.

Step 1300 is identical to step 315 except in that, responsive to an application of the H-CCP mode to a current block, the determination of the CCLM (or CCCM) model for the current block uses a H-CCLM (or H-CCCM) table updated according to the first embodiment. As usual when applying the H-CCP mode to the current block, the CCLM model (or the CCCM model) to apply to the current block is obtained from a CCLM model (or CCCM model) associated to a block encoded before the current block. However, in a majority of cases in inter slices, the block from which are obtained the CCLM (or CCCM) model was encoded using a mode different from the CCLM (or CCCM) coding mode, i.e., was encoded according to an inter mode. Indeed, the H-CCLM and H-CCCM tables were filled using cells of the PM buffer corresponding in majority to inter blocks.

If the current block is encoded according to the H-CCP mode, the CCLM (or CCCM) model used for the current block is stored (using the storeInfo process) in a cell (or in cells) of the PM buffer associated to the current picture corresponding to the current block in step 1301.

In a step 1302, responsive to the current block is encoded in inter mode, the spanInfo process according to the first embodiment is applied to the current block. During the applying of the spanInfo process, the cell(s) (called current cell) corresponding to the current block of the PM buffer associated to the current picture inherits from the coding parameters stored in the cell (called target cell) corresponding to a reference block designated by the motion information of the current block in the PM buffer associated to a reference picture. If the coding parameters comprise a CCLM (or CCCM) model, the model is also inherited. Therefore, the CCLM (or CCCM) model of the target cell is copied into the current cell.

FIG. 14 depicts schematically a method for decoding encoded video data according to an embodiment.

Comparing to the method of FIG. 4, the method of FIG. 14 comprises new steps 1401 and 1402 and step 415 is replaced by a step 1400. All additional steps are executed for example by the processing module 500 of the system 13.

Steps 1400, 1401, 1402 and 1403 are respectively identical to step 1300, 1301, 1302 and 1303.

The assumption that, when a current block is inter predicted either directly or indirectly from a block encoded using the CCCM or CCLM mode, the likelihood that the signal used to determine the CCLM (or CCCM) model is correlated to the chroma signal of the current block is high, is valid as long as the prediction error(s) committed during the inter prediction(s) is low.

In a variant of the first embodiment, the current cell inherits from the CCLM (or CCCM) model of the target cell in step 1302 and 1402 only if the inter prediction error of the current block is low. For instance, the current block inherits from the CCLM (or CCCM) models in step 1302 under the following condition:

DC_{curr}×QP<TH1

Where DC_{curr} is the value of the DC coefficient of the reconstructed residual of the current block, QP is the quantization parameter of the current block and TH1 is a predefined threshold.

In another variant of the first embodiment, the current cell inherits from the CCLM (or CCCM) model of the target cell in step 1302 and 1402 only if the number of successive applications of the spanInfo allowing storing the CCLM (or CCCM) model in the target cell is below a predefined threshold TH2.

The value DC_{curr}×QP and the number of successive applications of the spanInfo allowing storing the CCLM (or CCCM) model in the target cell can be considered as values representative of a quality of the CCLM (or CCCM) model inherited between the current cell and the target cell.

In a second embodiment, CCLM model or CCCM model or both are computed for all or some reconstructed blocks predicted using a prediction mode different from the CCLM or CCCM mode (i.e., either using an inter mode or in intra mode not using the CCLM or CCCM mode).

For example, whatever the actual mode of a reconstructed block is (inter, intra with or without CCLM or CCCM), a CCLM model or CCCM model or both are computed for the reconstructed block. Each computed model is then stored (using the storeInfo process) in the cell corresponding to the block of the PM buffer associated to the current picture.

In this example of the second embodiment, when the NA-CCP mode is applied to a current block, since a CCCM (or CCLM) model was computed for all blocks, a CCCM (or CCLM) model is available for all blocks in the neighborhood of the current block. In a first variant, the candidate region list is replaced by a candidate block list. A flag is signaled to indicate whether NA-CCP is applied the chroma block of the current block. If NA-CCP is applied, an index is signaled to indicate which candidate block in the candidate block list provides the CCCM (or CCLM) model to the current block.

In a second variant, the candidate region list is kept. However, in some cases a plurality of blocks may be comprised in a region. In that case, the CCCM (or CCLM) model of the block comprising a pre-determined (e.g., top left) pixel location of the region is considered as the CCCM (or CCLM) model of the region. Similarly, a block may cover at least partially several regions. Again, the CCCM (or CCLM) model of the block comprising the top-left pixel of the region is considered as the CCCM (or CCLM) model of the region.

In FIG. 13, an example of implementation of the second embodiment in the case of the NA-CCP mode is represented by the insertion of a step 1303 to the method of FIG. 3 in addition to steps 1300 and 1301. In this embodiment, step 1302 is not applied. During step 1303, the processing module 500 of the system 11 computes a CCCM (or CCLM) model for a current block if necessary. For instance, in step 1303, a CCCM (or CCLM) model is computed for each inter block and for each intra block not using the CCCM (or CCLM) mode of an inter slice. Each computed CCCM (or CCLM) model is stored in a cell of the PM buffer associated to the current picture corresponding to the current block.

In FIG. 14, an example of implementation of the second embodiment in the case of the NA-CCP mode is represented by the insertion of a step 1403 to the method of FIG. 4 in addition to steps 1400 and 1401. In this embodiment, step 1402 is not applied. Step 1403 is identical to step 1303.

When applying the NA-CCP mode to a current block, the CCCM (or CCLM) model to apply to the current block is obtained from a CCCM (or CCLM) model associated to a block encoded/decoded before the current block. However, again, in a majority of cases in inter slices, the block from which is obtained CCCM (or CCLM) model was encoded using a mode different from the CCCM (or CCLM) mode, i.e., was encoded according to an inter mode or to an intra mode note using the CCCM (or CCLM) mode. Indeed, the blocks of the candidate block list were encoded in inter mode or in an intra mode not using the CCCM (or CCLM) mode.

In a variant of the second embodiment when applied to the NA-CCP mode, in an inter slice, to avoid computing a CCCM (or CCLM) model for each block, a CCCM (or CCLM) model is computed only for a subset of blocks of the inter slice to insure that each block of the inter slice has at least one block in its candidate block list associated to a cell of a PM buffer comprising a CCCM (or CCLM) model. For instance, if the candidate block list comprises “6” block, each time the encoding module has reconstructed “6” blocks, it computes a CCCM (or CCLM) model.

In another variant avoiding computing a CCCM (or CCLM) model for each block, a frequency of computing the CCCM or CCLM model is predefined, for example, at pre-determined locations in pictures, after having reconstructed a given number of pixels, after having reconstructed a block of a given size.

In the second embodiment when applied to the H-CCP mode, in case of an inter slice, CCLM (or CCCM or both) model(s) is (are) computed for an inter block so that the H-CCLM and H-CCCM tables are updated even if the CCLM (or CCCM) mode is not used in the inter slice.

In FIG. 13, an example of implementation of the second embodiment in the case of the H-CCP mode is represented by the insertion of a step 1303 to the method of FIG. 3 in addition to steps 1300 and 1301. In this embodiment, step 1302 is not applied. During step 1303, the processing module 500 of the system 11 computes a CCLM (or CCCM or both) model for a reconstructed block if necessary (for example, if the reconstructed block was not yet encoded according to the CCLM or CCCM mode). For instance, in step 1303, a CCLM (or CCCM or both) model is computed for each inter block and for each intra block not using the CCLM (or CCCM) mode of an inter slice. After having computed the CCLM (or CCCM or both) model for the reconstructed block, the corresponding table (the H-CCLM table or the H-CCCM table) is updated with the CCLM (or CCCM) model of the current block. In step 1300, if a current block is coded with the CCLM (or CCCM) mode, a flag is signaled to indicate whether H-CCP is applied. If H-CCP is used, an index is further signaled to indicate which candidate model in the H-CCLM table or H-CCCM table is selected.

In FIG. 14, an example of implementation of the second embodiment in the case of the H-CCP mode is represented by the insertion of a step 1403 to the method of FIG. 4 in addition to steps 1400 and 1401. In this embodiment, step 1402 is not applied. Step 1403 is identical to step 1303. In step 1400, if a current block is coded with the CCLM (or CCCM) mode, a flag indicating whether H-CCP is applied to the current block is decoded. If H-CCP is used, an index indicating which candidate model in the H-CCLM table or H-CCCM table using is decoded.

Therefore, when applying the NA-CCP mode to a current block in step 1300 and 1400, the CCCM model to apply to the current block is obtained from a CCCM model associated to a block encoded/decoded before the current block. However, again, in a majority of cases in inter slices, the block from which is obtained CCCM model was encoded using a mode different from the CCCM coding mode, i.e., was encoded according to an inter mode or to an intra mode note using the CCCM mode. Indeed, the models in the H-CCLM table or H-CCCM table are associated to blocks encoded in inter mode or in an intra mode not using the CCLM or CCCM modes.

In a variant of the second embodiment, step 1302 (resp. 1402) is applied by the encoding module (resp, the decoding module) when a CCLM (or CCCM) model is not computed for each inter block or intra block not using the CCLM (or CCCM) mode. For example, in this variant, the model is only computed for inter blocks that would inherit CCLM (or CCCM) model from an inter block via the spanInfo process. The model is not computed for inter blocks inheriting CCLM (or CCCM) model from an intra block using the CCLM (or CCCM) mode via the spanInfo process.

In the example of FIG. 12, no CCLM (or CCCM) model is computed for the block B1 since it inherits its model from an INTRA block. However, since block B2 would inherit its CCLM (or CCLM) model from the inter block B1 via the spanInfo process, a new CCLM (or CCCM) model is computed for block B2.

In another embodiment, the cells size of the grid of the PM buffer used for storing CCCM and CCLM models is different as the regular PM buffer for storing the intra prediction mode or for storing the motion information. For example, the PM buffer for storing the intra prediction mode or for storing the motion information is 4×4, whereas the cells size of the grid of the PM buffer used for storing CCCM and CCLM models is 8×8. Increasing the size of the cells allows for reducing the amount of internal memory, whereas reducing the size of the cells allows increasing the accuracy and the number of CC-model candidates potentially.

In a variant, the cells size may vary per frame. For example, one may allocate fewer memory (greater cells size) for some slices or pictures. The selection/derivation of the cells size may be function of the temporal id of the frame.

In another embodiment, the precision for the CC-models parameters may be reduced to reduce the internal memory. For example, one may use 64-bits for deriving the CC-models parameters and use 32-bits for storage in the PM buffer.

In another embodiment, the CCCM and CCLM models are stored into a look up table (LUT) and the PM buffer stores an index pointing to the LUT (FIG. 15). In that way, the CCCM and CCLM models are not duplicated into the grid and only one index is stored in each cell. One LUT is associated to each picture. The spanInfo process can be modified by inheriting and/or copying index rather than the CCCM and CCLM model parameters directly. In a variant, in case of picture or slice coded in inter, a process for converting the indexes of one reference picture into new indexes for the current picture and for updating the current LUT with CCCM and CCLM models from the reference picture LUT is applied.

For all the blocks coded in inter, the spanInfo process can be invoked to update the current LUT with models stored in the reference LUTs, and fill-in the current PM buffer with new indexes converted from the indexes in the reference PM buffer.

In a variant, the size of the LUT is limited to a predefined or signaled value maxLUT. If the size of the LUT is maxLUT, then no more CCCM or CCLM model parameters are stored nor referenced in the LUT.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g., using a monitor, screen, or other type of display) a resulting picture.
A TV, set-top box, cell phone, tablet, or other electronic device that tunes (e.g., using a tuner) a channel to receive a signal including an encoded video stream, and performs at least one of the embodiments described.
A TV, set-top box, cell phone, tablet, or other electronic device that receives (e.g., using an antenna) a signal over the air that includes an encoded video stream, and performs at least one of the embodiments described.
A server, camera, cell phone, tablet or other electronic device that transmits (e.g., using an antenna) a signal over the air that includes an encoded video stream, and performs at least one of the embodiments described.
A server, camera, cell phone, tablet or other electronic device that tunes (e.g., using a tuner) a channel to transmit a signal including an encoded video stream, and performs at least one of the embodiments described.

1-24. (canceled)

25. A method for decoding video data comprising:
obtaining a first block to reconstruct using a cross-component coding mode in which a model of the cross-component coding mode to apply to reconstruct the first block is obtained from a model of the cross-component coding mode associated to a reconstructed second block, wherein the second block was reconstructed using a mode different from the cross-component coding mode.

26. The method according to claim 25, wherein the model of the cross-component coding mode associated to the reconstructed second block is stored in at least one cell corresponding to the second block of a first buffer storing coding parameters of blocks of a current picture comprising the first block and the reconstructed second block.

27. The method of claim 26, wherein a cell of the at least one cell inherited the model of the cross-component coding mode associated to the reconstructed second block from another cell corresponding to a reference block of a reference picture designated by motion information of the second block, the other cell being comprised in a second buffer storing coding parameters of blocks of the reference picture.

28. The method of claim 27, wherein the cell of the at least one cell inherited the model of the cross-component coding mode associated to the reconstructed second block from the another cell depending on a value representative of a quality of the model of the cross-component coding mode inherited by the first block from the second block.

29. The method of claim 25, wherein the model of the cross-component coding mode to apply to the first block is selected from a table storing models of the cross-component coding mode of last reconstructed blocks for which a model of the cross-component coding mode is available, the table being updated after a reconstruction of a block for which a model of the cross-component coding mode is available.

30. The method of claim 25, wherein the model of the cross-component coding mode to apply to the first block is selected from models of the cross-component coding mode of a candidate region list or of a candidate block list, regions of the candidate region list and blocks of the candidate block list being in a neighborhood of the first block.

31. The method of claim 25, wherein a model of the cross-component coding mode is computed for reconstructed blocks predicted using a mode different from the cross-component coding mode.

32. The method of claim 25, wherein information representative of the model of the cross-component coding mode applied to reconstruct the first block is stored in at least one cell corresponding to a current block of a current buffer storing coding parameters associated to the current picture.

33. A method for encoding video data comprising:
applying a cross-component coding mode to a first block, a model of the cross-component coding mode to apply to the first block being obtained from a model of the cross-component coding mode associated to a second block encoded before the first block, wherein the second block was encoded using a mode different from the cross-component coding mode.

34. A device for decoding video data comprising electronic circuitry configured for:
obtaining a first block to reconstruct using a cross-component coding mode in which a model of the cross-component coding mode to apply to reconstruct the first block is obtained from a model of the cross-component coding mode associated to a reconstructed second block, wherein the second block was reconstructed using a mode different from the cross-component coding mode.

35. The device according to claim 34, wherein the model of the cross-component coding mode associated to the reconstructed second block is stored in at least one cell corresponding to the second block of a first buffer storing coding parameters of blocks of a current picture comprising the first block and the reconstructed second block.

36. The device of claim 35, wherein a cell of the at least one cell inherited the model of the cross-component coding mode associated to the reconstructed second block from another cell corresponding to a reference block of a reference picture designated by motion information of the second block, the other cell being comprised in a second buffer storing coding parameters of blocks of the reference picture.

37. The device of claim 36, wherein the cell of the at least one cell inherited the model of the cross-component coding mode associated to the reconstructed second block from the other cell depending on a value representative of a quality of the model of the cross-component coding mode inherited by the first block from the second block.

38. The device of claim 34, wherein the model of the cross-component coding mode to apply to the first block is selected from a table storing models of the cross-component coding mode of last reconstructed blocks for which a model of the cross-component coding mode is available, the table being updated after a reconstruction of a block for which a model of the cross-component coding mode is available.

39. The device of claim 34, wherein the model of the cross-component coding mode to apply to the first block is selected from models of the cross-component coding mode of a candidate region list or of a candidate block list, regions of the candidate region list and blocks of the candidate block list being in a neighborhood of the first block.

40. The device of claim 34, wherein a model of the cross-component coding mode is computed for reconstructed blocks predicted using a mode different from the cross-component coding mode.

41. The device of claim 34, wherein information representative of the model of the cross-component coding mode applied to reconstruct the first block is stored in at least one cell corresponding to a current block of a current buffer storing coding parameters associated to the current picture.

42. A device for encoding video data comprising electronic circuitry configured for:
applying a cross-component coding mode to a first block, a model of the cross-component coding mode to apply to the first block being obtained from a model of the cross-component coding mode associated to a second block encoded before the first block, wherein the second block was encoded using a mode different from the cross-component coding mode.

43. The device according to claim 42, wherein the model of the cross-component coding mode associated to the second block is stored in at least one cell corresponding to the second block of a first buffer storing coding parameters of blocks of a current picture comprising the first block and the second block.

44. Non-transitory information storage medium storing program code instructions for implementing the method according to claim 25.
